(19) United States
(12) Patent Application Publication
(10) Pub. No.: US 2012/0061052 A1
(43) Pub. Date: Mar. 15, 2012

(54) HYDRONIC SYSTEM

(75) Inventors: Roberto Alessandrelli, Milano (MI) (IT); Alfonso Citarella, Villasanta (MI) (IT)

(73) Assignee: CARRIER CORPORATION, Farmington, CT (US)

(21) Appl. No.: 12/879,681

(22) Filed: Sep. 10, 2010

(51) Int. Cl. F28F 9/00; B23P 19/00; F28D 15/00

(52) U.S. Cl. 165/67; 165/104.19; 29/428; 29/525.11

(57) ABSTRACT

A hydronic system (2) includes a vessel (4) having an external surface (8) and an internal surface (9) that defines a hollow interior portion (12) configured and disposed to store a first fluid medium. A heat exchange member (34) includes a body member (36) housing a heat exchange element (38) configured to facilitate an exchange of heat between the first fluid medium and a second fluid medium. The heat exchange member (34) is directly hydraulically connected to the vessel.

### BACKGROUND OF THE INVENTION

Exemplary embodiments pertain to the art of hydronic systems and, more particularly, to a heat exchanger/pressure vessel assembly for a hydronic system.

Hydronic systems deliver conditioned fluid (water) through a heat exchange device to heat and/or cool a space. Conventionally, the fluid is either heated or cooled in the heat exchanger before being passed to a vessel. In the heat exchanger, a heat transfer takes place between the fluid and another medium. At present, plate heat exchangers are growing in popularity due to a speed of exchange between two mediums. More specifically, plate heat exchangers employ a series of plates, typically formed from metal, having a large surface area that facilitates a heat transfer between two mediums. The large surface area of the plates speed the heat transfer between mediums.

### BRIEF DESCRIPTION OF THE INVENTION

Disclosed is a hydronic system including a vessel including an external surface and an internal surface that defines a hollow interior portion configured and disposed to store a first fluid medium. A heat exchange member includes a body member housing a heat exchange element configured to facilitate an exchange of heat between the first fluid medium and a second fluid medium. The heat exchange member is directly hydraulically connected to the vessel.

Also disclosed is a method of mounting a heat exchange member to a vessel for a hydronic system. The method includes positioning an outlet to the heat exchange member at an inlet of the vessel, and establishing a direct hydraulic connection between the heat exchange member and the vessel by joining the outlet and the inlet.

### BRIEF DESCRIPTION OF THE DRAWINGS

The following descriptions should not be considered limiting in any way. With reference to the accompanying drawings, like elements are numbered alike:

FIG. 1 depicts a heat exchanger member secured to a vessel of a hydronic system in accordance with an exemplary embodiment;

FIG. 2 is a exploded view of the hydronic system of FIG. 1;

FIG. 3 is a cross-sectional view of the heat exchange member and vessel of FIG. 1; and

FIG. 4 is a detail cross-sectional view of a connection between the heat exchange member and vessel of FIG. 1.

### DETAILED DESCRIPTION OF THE INVENTION

A detailed description of one or more embodiments of the disclosed apparatus and method are presented herein by way of exemplification and not limitation with reference to the Figures.

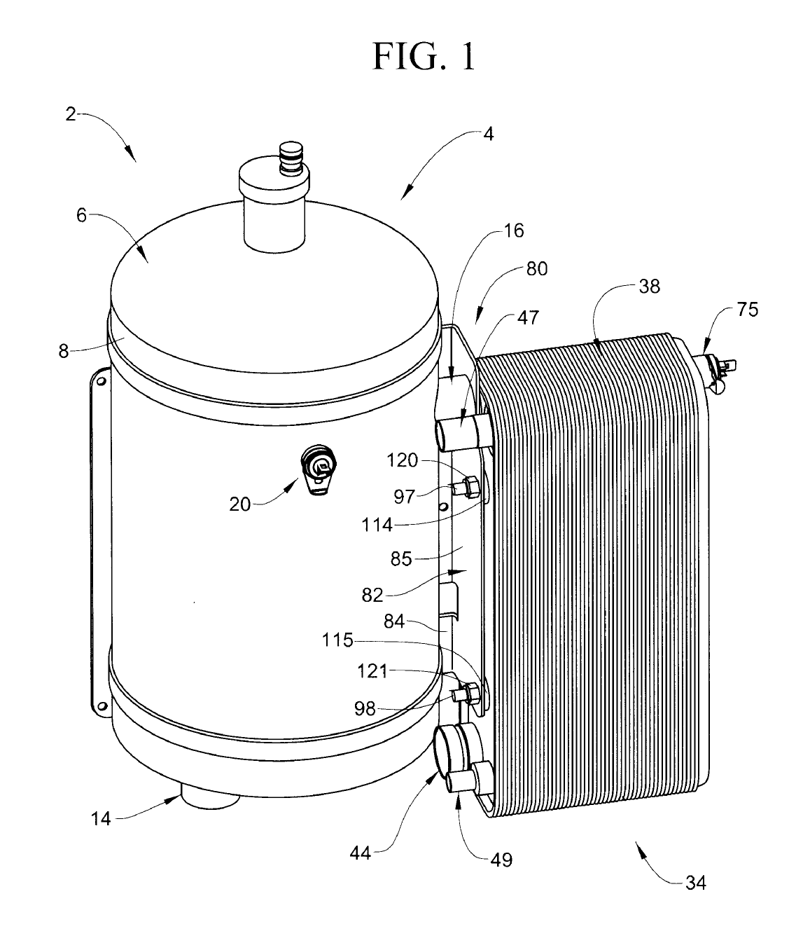

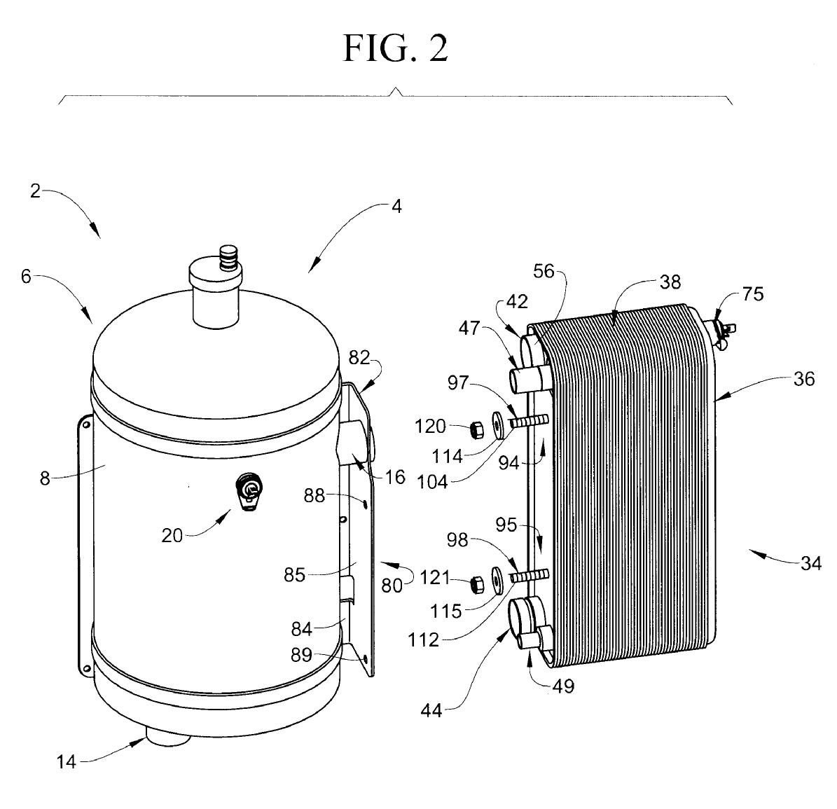

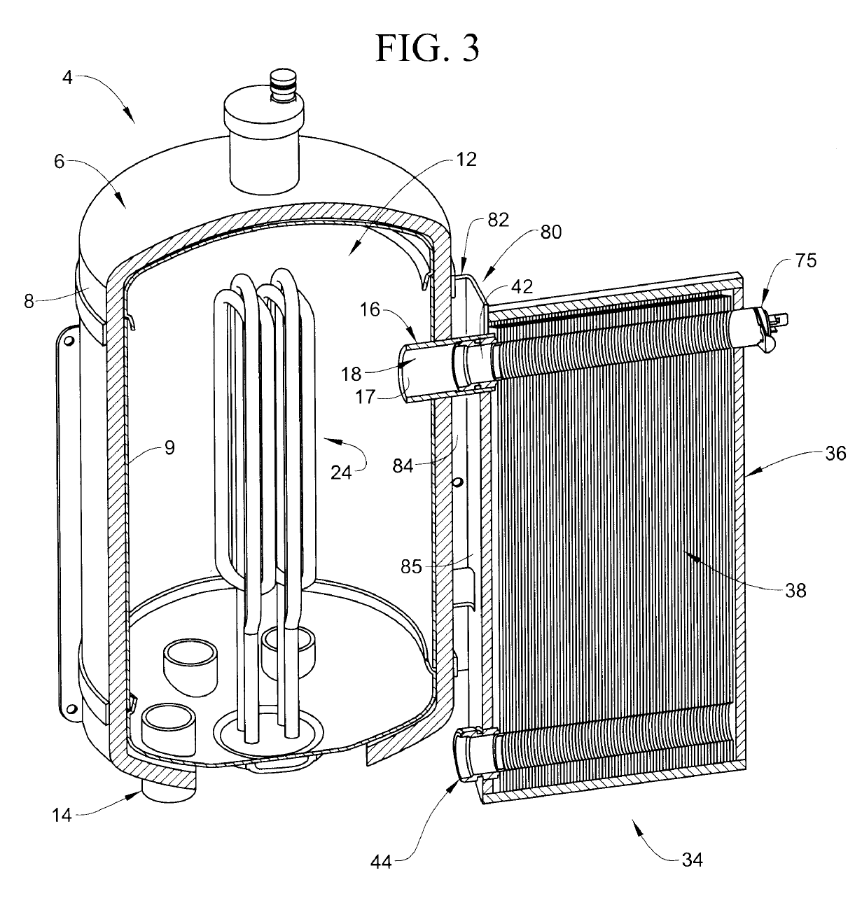

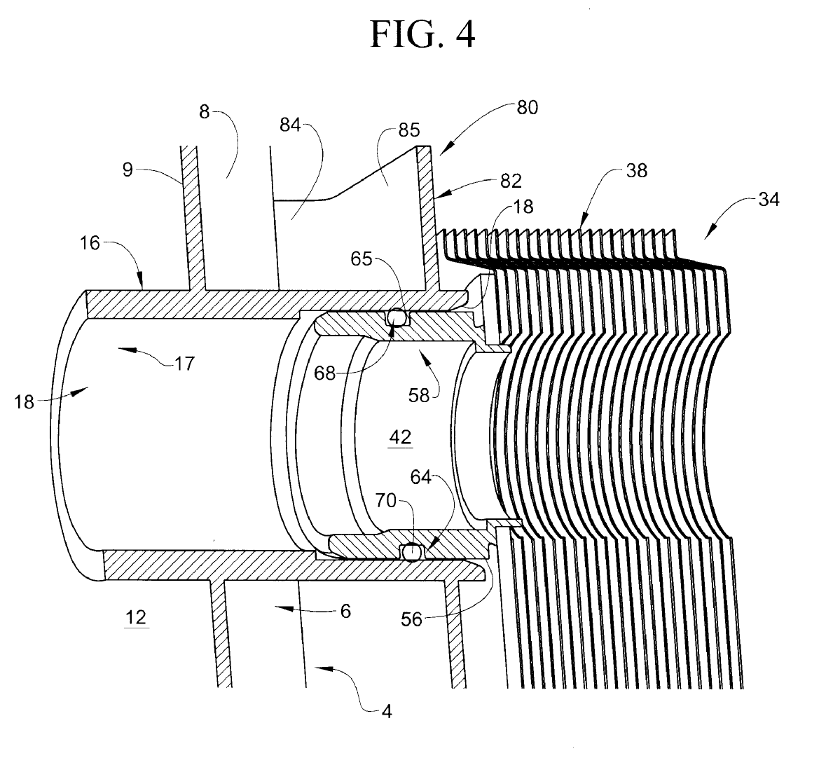

With reference to FIGS. 1-4 a hydronic system in accordance with an exemplary embodiment is indicated generally at 2. Hydronic system 2 is employed to provide heating and/or cooling to living/working spaces by conditioning a fluid that is passed through a fan coil, radiator, radiant flooring and the like. Hydronic system 2 includes a vessel 4 having a body 6. Body 6 includes an external surface 8 and an internal surface 9 that defines a hollow interior portion 12 that is configured to store a first fluid medium, such as water. Vessel 4 includes an outlet 14 and an inlet 16. Inlet 16 includes an interior wall 17 that establishes an opening 18. Interior wall 17 also defines a sealing surface (not separately labeled) as will be detailed more fully below. Vessel 4 is also shown to include a temperature sensor 20 and an electrical heater 24. Electrical heater 24 is selectively operated, together with a heat exchange member 34 to establish a desired temperature for the first fluid medium stored in hollow interior portion 12.

In accordance with an exemplary embodiment, hydronic system 2 also includes a heat exchange member 34. As will be detailed more fully below, heat exchange member 34 is mounted to external surface 8 of vessel 4. Heat exchange member 34 includes a body member 36 which houses a heat exchange element shown in the form of a plurality of plates 38. In this manner heat exchange member 34 defines a plate heat exchanger. In accordance with one exemplary aspect, heat exchange member 34 defines a brazed plate heat exchanger.

Heat exchange member 34 includes a first outlet 42 and a first inlet 44. First inlet 44 receives the first fluid medium from a fluid circuit (not shown) while first fluid outlet 42 passes the first fluid to vessel 4. Heat exchange member 34 also includes a second outlet 47 and a second inlet 49. Second outlet 47 passes a second fluid medium, such as water or a refrigerant that is passed in a heat exchange relationship with the first fluid medium. Once conditioned, the first fluid medium passes from outlet 14 of vessel 4 to, for example, a fan coil, a radiator, or through radiant flooring in order to condition a space. The term “conditioned” should be understood to mean that hydronic system 2 provides heating and/or cooling to the space such as a room or rooms, offices, storage areas, work areas and the like. First outlet 42 includes an external surface 56 and an internal surface 58. External surface 56 includes a seal land 64 shown in the form of a groove 65 that receives a seal 68. In the exemplary embodiment shown, seal 68 takes the form of an O-ring 70, however it should be understood that the particular form of seal land 64 and seal 68 could vary. Heat exchange member 34 is also shown to include a temperature sensor 75 fluidly connected to first outlet 42. Temperature sensor 75 senses a temperature of the first fluid medium passing from heat exchange member 34 into vessel 4.

In further accordance with an exemplary embodiment, vessel 4 includes a mounting member 80 provided on external surface 8. In the exemplary embodiment shown, mounting member 80 takes the form of a flange 82 having a first section 84 that extends from external surface 8 and a second section 85 that extends substantially perpendicularly from first section 84. Second section 85 includes a plurality of openings 88 and 89 that are configured to receive a corresponding plurality of mounting elements 94 and 95 associated with heat exchange member 34. In the exemplary embodiment shown, mounting elements 94 and 95 take the form of threaded fasteners 97 and 98 that are connected to body member 36 of heat exchange member 34. Threaded fastener 97 includes a plurality of threads 104. Similarly, threaded fastener 98 includes plurality of threads 112. First and second ends threaded fasteners 97 and 98 pass through openings 88 and 89 of flange 82. A first washer 114 is positioned upon first threaded fastener 97, and a second washer 115 is positioned upon second threaded fastener 98. First and second washers are positioned between heat exchange member 34 and flange 82. Threaded fastener 97 is provided with a first nut 120 and second threaded fastener 98 is provided with a second nut 121.

With this arrangement, heat exchange member 34 is positioned adjacent vessel 4 with first outlet 42 registering with inlet 16. First and second threaded fasteners 97 and 98 are passed through washers 114 and 115 and then openings 88 and 89 on flange 82. First and second nuts 120 and 121 are secured to threaded fasteners 97 and 98 thereby establishing a direct hydraulic connection between heat exchange member 34 and vessel 4. Direct hydraulic connection should be understood to mean that there are no intermediate conduit(s) connecting vessel 4 and heat exchange member 34. As the direct hydraulic connection is established, heat exchange member 34 is drawn to vessel 4, first outlet 42 is seated within inlet 16 with O-ring 70 forming an interference seal to prevent leakage of the first fluid medium.

At this point it should be understood that the exemplary embodiments provide a hydronic system having a heat exchange member that is mounted directly to a vessel that stores a heat exchange medium. By mounting the heat exchange member directly to the vessel, a direct hydraulic connection is formed thereby eliminating any the need for various interconnecting pipes that would otherwise require multiple connections that create various leak points. By doing away with the interconnecting pipes, not only is production/manufacturing time and complexity decreased, but an overall form factor of the hydronic system is reduced. Also, eliminating the interconnecting pipes reduces an overall number of leak points that may present service issues over the operational life of the hydronic system.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A hydronic system (2) comprising:
a vessel (4) including an external surface (8) and an internal surface (9) that defines a hollow interior portion (12) configured and disposed to store a first fluid medium; and
a heat exchange member (34) including a body member (36) housing a heat exchange element (38) configured to facilitate an exchange of heat between the first fluid medium and a second fluid medium, the heat exchange member being directly hydraulically connected to the vessel.

2. The hydronic system according to claim 1, further comprising:
a mounting member (80) provided on the vessel (4); and
a mounting element (94, 95) provided on the heat exchange member (34), the mounting element (94, 95) engaging with the mounting member (80) to form a mechanical connection that establishes the direct hydraulic connection between the heat exchange member (34) and the vessel (4).

3. The hydronic system (2) according to claim 2, wherein the mounting member (80) is a flange (82) mounted to the external surface (8) of the vessel (6).

4. The hydronic system according to claim 3, wherein the mounting element (94, 95) comprises a threaded fastener (97, 98) including a nut (120,121).

5. The hydronic system according to claim 4, wherein the flange (82) includes an opening (88, 89), the threaded fastener (97, 98) passing through the opening (88, 89).

6. The hydronic system according to claim 2, wherein the mounting element (94, 95) extends from the body (36) member of the heat exchange member (34).

7. The hydronic system according to claim 1, wherein the heat exchange member (34) is a plate heat exchanger.

8. The hydronic system according to claim 7, wherein the plate heat exchanger is a brazed plate heat exchanger.

9. The hydronic system (2) according to claim 1, wherein the vessel (4) includes an inlet (16) for the first fluid medium and the heat exchange member (34) includes an outlet (42) for the first fluid medium, one of the outlet (42) and the inlet (16) including a seal (68).

10. The hydronic system (2) according to claim 9, wherein the seal (68) is an O-ring (70).

11. They hydronic system (2) according to claim 9, wherein the inlet (16) includes a seal land (69), the seal (68) being arranged in the seal land (64).

12. A method of mounting a heat exchange member (34) to a vessel (4) for a hydronic system (2), the method comprising:
positioning an outlet (42) to the heat exchange member (34) at an inlet (16) of the vessel (4); and
establishing a direct hydraulic connection between the heat exchange member (34) and the vessel (4) by joining the outlet (42) and the inlet (16).

13. The method of claim 12, wherein establishing the direct hydraulic connection includes forming a direct mechanical connection between the heat exchange member (34) and the vessel (4).

14. The method of claim 13, wherein establishing the direct mechanical connection includes interconnecting a mounting element (94, 95) provided on the heat exchange member (34) with a mounting member (80) provided on the vessel (4).

15. The method of claim 14, wherein interconnecting the mounting element (94, 95) with the mounting member (80) includes securing a threaded fastener (97, 98) to a flange (82).

16. The method of claim 12, further comprising: providing seal (68) between the inlet (16) and the outlet (42) upon interconnecting the mounting element (94, 95) and the mounting member (80).

17. The method of claim 12, wherein positioning the inlet (16) at the outlet (42) includes passing the outlet (42) into an opening (18) of the inlet (16).

18. The method of claim 17, forming an interference seal (68) between the inlet (16) and the outlet (42).

19. The method of claim 18, wherein forming the interference seal comprises passing an O-ring (70) extending about the outlet (42) into the opening (18) formed in inlet (16).

20. The method of claim 12, wherein establishing the direct hydraulic connection comprises drawing the outlet (42) of the heat exchange member (34) into the inlet (16) of the vessel (4).
